(19) United States
(12) Patent Application Publication
(10) Pub. No.: US 2007/0288909 A1
(43) Pub. Date: Dec. 13, 2007

(54) Hardware JavaTM Bytecode Translator

(75) Inventors: Wei Lun Alan Cheung, Hong Kong (CN); Pak Lun Moky Mok, Hong Kong (CN); Felix Chow, Hong Kong (CN)

Correspondence Address: THE H.T. THAN LAW GROUP, WATERFRONT CENTER SUITE 560, 1010 WISCONSIN AVENUE NW, WASHINGTON, DC, 20007, US

(73) Assignee: Hong Kong Applied Science and Technology Research Institute Company Limited, Hong Kong (HK)

(21) Appl. No.: 11/422,626

(22) Filed: Jun. 7, 2006

(51) Int. Cl. G06F 9/45

(52) U.S. Cl. 717/136

(57) ABSTRACT

A system comprising a central processing unit (102) for use in executing RISC instructions and a hardware unit (100) associated with the central processing unit (102), is disclosed. The hardware unit (100) is configured for translating stack-based instructions into RISC instructions for execution by the central processing unit (102). The translation is performed using a programmable lookup table.

### FIELD OF THE INVENTION

The present invention relates generally to computer systems and, in particular, to hardware processors that implement virtual computing machines.

### BACKGROUND

Java™ is a well known object orientated programming language which was developed by Sun Microsystems™. The use of Java™ has increased in popularity in recent times, particularly on the Internet, since Java™ is simple, distributed, and portable across platforms and operating systems.

Most conventional programming languages use a compiler to translate the source code of a program into machine code or processor instructions, which are native to a central processing unit (CPU) of a particular operating system. However, once translated, the program will only execute on that particular operating system. In order for the program to be executed on a different operating system, the original source code must be recompiled for the CPU of this different operating system.

Java™ programs are typically compiled for a Java™ Virtual Machine. A Java™ Virtual Machine is an abstract computer that executes the compiled Java programs. The Java™ Virtual Machine is referred to as ‘virtual’ since it is implemented in software on a ‘real’ hardware platform and operating system. Accordingly, the Java™ Virtual Machine needs to be implemented on a particular platform for compiled Java™ programs to be executed on that platform.

The Java™ Virtual Machine sits between the compiled Java program and the underlying hardware platform and operating system. The portability of the Java™ programming language is provided largely by the Java™ Virtual Machine, since compiled Java™ programs run on the Java™ Virtual Machine, independent of whatever may be underneath the Java™ Virtual Machine.

In contrast to conventional programming languages, Java™ programs are compiled into a form called Java™ bytecodes. The Java™ Virtual Machine executes these Java™ bytecodes. So Java™ bytecodes essentially form the machine language of the Java™ Virtual Machine. The Java™ Virtual Machine comprises a Java™ compiler that reads a source of Java™ language source (e.g., in the form of java files), translates the source into Java™ bytecodes.

A stream of bytecodes is seen as a sequence of instructions by the Java™ Virtual Machine. Each of these instructions comprises a one-byte opcode and zero or more operands. The opcode indicates to the Java™ Virtual Machine what action to take. Immediately following the opcode may be other information (e.g., operands), if the Java™ Virtual Machine requires such information to perform the particular action.

Each bytecode instruction has a corresponding mnemonic. These mnemonics essentially form the assembly language for the Java™ Virtual Machine. For example, one of the Java™ instructions causes the Java™ Virtual Machine to push a zero onto a Java™ stack. This instruction has the mnemonic ‘iconist_{—}0’, and its bytecode value is 60 hex. The iconist_{—}0 instruction does not require any operands.

The virtual hardware of the Java™ Virtual Machine comprises four basic parts: registers, a stack, a trash area, and a method area. These parts are abstract, just like the Java™ Virtual Machine they compose, but they must exist in some form in every Java™ Virtual Machine implementation.

The Java™ Virtual Machine can address up to four gigabytes of memory, with each memory location containing one byte. Each register in the Java™ Virtual Machine stores one 32-bit address. The stack, the trash, and the method area are positioned somewhere within the four gigabytes of addressable memory depending on the particular implementation of the Java™ Virtual Machine.

A word in the Java™ Virtual Machine is 32 bits. The Java™ Virtual Machine also has a small number of primitive data types (e.g., byte (8 bits), int (32 bits) and float (32 bits)). These types conveniently map to the types available to a Java™ programmer.

The method area contains bytecodes. As such, the method area is aligned on byte boundaries. The Java™ stack and trash are aligned on word (32-bit) boundaries.

The Java™ Virtual Machine has a program counter and several other general registers that manage the Java™ stack. The Java™ Virtual Machine has only a small number of registers since the bytecode instructions of the Java™ Virtual Machine operate primarily on the Java™ stack. Such a stack-based design allows the instruction set of the Java™ Virtual Machine and the implementation thereof to be small.

As described above, the Java™ Virtual Machine uses a Java™ program counter to maintain where in memory the Java™ Virtual Machine is executing instructions. Other registers point to various parts of the stack frame of a currently executing method. The stack frame of an executing method stores the state (e.g., local variables (LV) and intermediate results of calculations, etc.) for a particular invocation of the method.

As described above, the method area contains the Java™ bytecodes. The program counter always stores the address of some byte in the method area. After a bytecode instruction has been executed, the program counter will contain the address of the next instruction to be executed by the Java™ Virtual Machine. Following execution of an instruction, the Java™ Virtual Machine typically sets the program counter to the address of the instruction that immediately follows the previous one.

The parameters for and results of bytecode instructions are stored in the Java™ stack. The Java™ stack is also used to pass parameters to and return values from methods. Further, the Java™ stack stores the state of each method invocation, where the state of a method invocation is called the method's stack frame, as described above.

The objects of a Java™ program reside in the trash area of the Java™ Virtual Machine. Any time memory is allocated with a new operator, the allocated memory comes from the trash. Allocated memory is not able to be freed directly using the Java™ programming language. Instead, the runtime environment maintains the references to each object in the trash. The runtime environment may then automatically free the memory occupied by objects that are no longer referenced.

The Java™ Virtual Machine also comprises a Java™ byte code interpreter. The Java™ byte code interpreter converts bytecodes into machine code or processor instructions that are native to a particular CPU. For example, a request to establish a socket connection to a remote CPU will involve an operating system call. Different operating systems handle sockets in different ways. The Java™ Virtual Machine will handle the socket translations, so that the operating system and CPU architecture on which Java™ programs are running is completely irrelevant.

However, the execution of Java™ programs is relatively slow compared to some programs coded according to a conventional programming language, because of the need for the Java™ bytecodes of the programs to be processed and translated by the Java™ Virtual Machine. For example, for a Java™ program executing on a particular CPU, the CPU must firstly execute the Java™ Virtual Machine to translate the Java™ bytecodes of the program into native instructions. These native instructions must then be executed by the CPU. The translation of the bytecodes into native instructions causes a bottleneck in the execution of the Java™ programs.

The execution of Java™ programs as described above may be compared to a conventional program being executed by a CPU for which the conventional program has been compiled. In this instance, the processor must merely execute the native instructions for the conventional program.

Specialised interpreters have been used to increase the execution speed of the Java™ Virtual Machine and accordingly increase the execution speed of a Java™ program. However, these specialised interpreters often result in both a compile overhead and an additional memory overhead for an operating system in which they are being used. As a result, the use of Java™ has been limited in low memory and low energy consumption implementations.

Another known method of increasing the execution speed of Java™ programs is through the use of a hardware Java™ accelerator such as that disclosed by U.S. Pat. No. 6,332,215 to Patel, et al. This hardware Java™ accelerator implements portions of the Java™ virtual machine in hardware in order to accelerate the operation of an operating system generating Java™ bytecodes. The hardware Java™ accelerator of U.S. Pat. No. 6,332,215 also translates bytecodes into native processor instructions. However, one disadvantage of the hardware Java™ accelerator of U.S. Pat. No. 6,332,215 is that it requires the use of multiple hardware Java™ registers. These hardware Java™ registers are required to store Java™ register files defined in the Java™ virtual machine. The register files contain the state of the Java™ virtual machine and are updated after each bytecode is executed. The need for such multiple hardware Java™ registers complicates the hardware necessary to execute the Java™ programs.

Another hardware Java™ accelerator is that disclosed by U.S. Pat. No. 6,965,984 to Seal, et al. However, the hardware Java™ accelerator of U.S. Pat. No. 6,965,984 is only designed for use with central processing units produced by a company called ARM Limited of Cambridge, England and the instruction set of such ARM central processing units.

Thus, a need clearly exists for an improved and more efficient means of increasing the execution speed of Java™ programs.

### SUMMARY

It is an object of the present invention to substantially overcome, or at least ameliorate, one or more disadvantages of existing arrangements.

The present invention generally relates to a hardware Java™ bytecode unit for use in translating Java™ bytecodes into native instructions for a particular central processing unit (CPU). The hardware Java™ bytecode unit increases the processing speed of Java™ bytecodes compared to Java™ Virtual Machines implemented purely in software, by using a programmable lookup table to perform the translation.

The hardware Java™ bytecode unit of the present invention minimises hardware complications by converting stack-based Java™ bytecodes into register-based native instructions for a particular CPU using an original CPU register file for all stack operations.

According to one aspect of the present invention there is provided a system comprising:

a central processing unit for use in executing RISC instructions; and

a hardware unit associated with the central processing unit, the hardware unit being configured for translating stack-based instructions into RISC instructions for execution by said central processing unit, wherein the translation is performed using a programmable lookup table.

According to another aspect of the present invention there is provided a system comprising:

a central processing unit for use in executing RISC instructions, said central processing unit comprising a CPU register file; and

a hardware unit associated with the central processing unit, the hardware unit being configured for translating stack-based instructions into RISC instructions using an operand stack configured within the CPU register file, wherein the operand stack is managed by the hardware unit and is used for performing the stack operations necessary in performing said translations.

According to still another aspect of the present invention there is provided a method of translating a stack-based instruction into RISC instructions for execution by a central processing unit, said method comprising the steps of:

downloading the stack-based instruction to a hardware unit associated with the central processing unit;

matching the stack-based instruction to one or more RISC instructions stored in a programmable lookup table, using the hardware unit; and

executing the one or more RISC instructions using the central processing unit.

According to still another aspect of the present invention there is provided an apparatus comprising:

a central processing unit for use in executing RISC instructions; and a hardware unit associated with the central processing unit, the hardware unit being configured for translating stack-based instructions into RISC instructions for execution by said central processing unit, wherein the translation is performed using a programmable lookup table to match stack-based instructions to one or more RISC instructions stored in the programmable lookup table. Other aspects of the invention are also disclosed.

### BRIEF DESCRIPTION OF THE DRAWINGS

Some aspects of the prior art and one or more embodiments of the present invention will now be described with reference to the drawings and appendices, in which:

FIG. 1 shows a hardware Java™ bytecode unit connected to a reduced instruction set computer (RISC) CPU, in accordance with one embodiment of the present invention;

FIG. 2 shows details of one embodiment of the hardware Java™ bytecode unit of FIG. 1;

FIG. 3 shows the sections in a Java™ stack frame;

FIG. 4 shows the mapping of the Java™ stack to a Java™ register stack;

FIG. 5 shows five words stored in a context information (CI) section of a stack frame;

FIG. 6(a) shows the Java™ register stack prior to translation of an iadd bytecode; and

FIG. 6(b) shows the Java™ register stack of FIG. 6(a) after the translation of the iadd bytecode

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

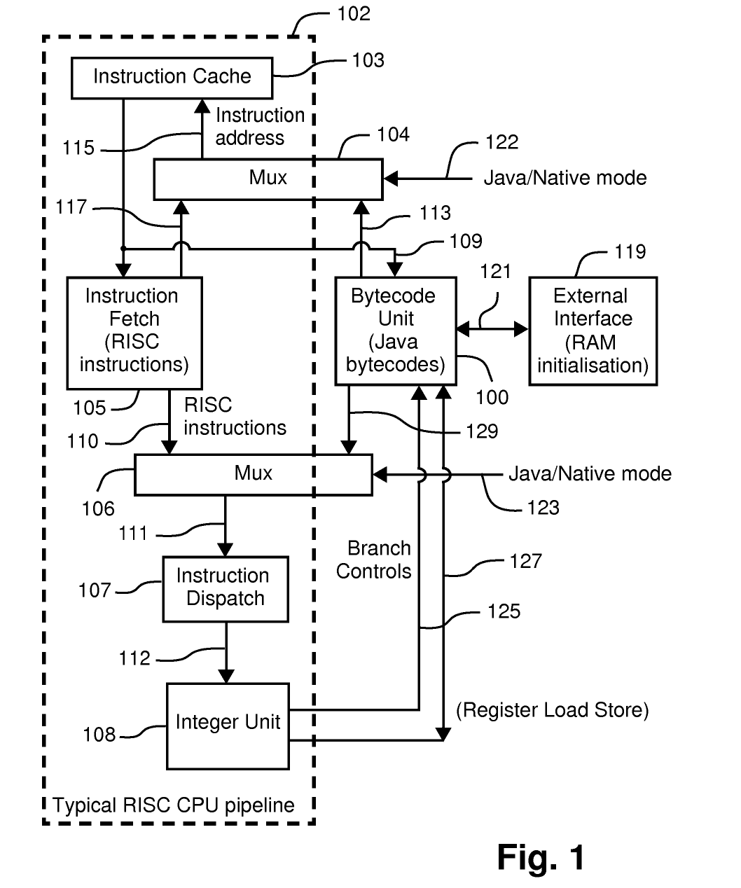

It is to be noted that the discussions contained in the “Background” section and that above relating to prior art arrangements relate to discussions of documents or devices which form public knowledge through their respective publication and/or use. Such should not be interpreted as a representation by the present inventor(s) or patent applicant that such documents or devices in any way form part of the common general knowledge in the art. FIG. 1 shows a hardware Java™ bytecode unit 100 connected to a RISC CPU 102, in accordance with one embodiment of the present invention. The hardware Java™ bytecode unit 100 generates RISC instructions to be executed by the CPU 102 which may be a generic register based CPU. The principles of the hardware Java™ bytecode unit 100 are not limited to the Java™ programming language. The hardware Java™ bytecode unit 100 may be used with any stack-based language that is to be converted to register-based native instructions. The hardware Java™ bytecode unit 100 may also be used with any programming language which is executed by a virtual machine similar to the Java™ virtual machine.

The hardware Java™ bytecode unit 100 increases the processing speed of Java™ bytecodes compared to Java™ Virtual Machines implemented purely in software, by using a programmable lookup table to perform the translation. Further, the hardware Java™ bytecode unit 100 of the present invention minimises necessary hardware by translating stack-based Java™ bytecodes into register-based RISC instructions for the CPU 102 using a CPU register file for all stack operations.

The CPU register file is used to store general registers defined for a Java™ virtual machine being executed by the CPU 102. The CPU register file is also used to store special registers used by the hardware Java™ bytecode unit 100. In accordance with preferred embodiment, the CPU register file is used by the CPU 102 both when executing RISC instructions native to the CPU 102 (i.e., when the CPU 102 is operating in “native mode”) and when the hardware Java™ bytecode unit 100 is translating stack-based Java™ bytecodes into register-based RISC instructions (i.e., when the CPU 102 is operating in “Java™ mode).

The special registers used by the hardware Java™ bytecode unit 100 of the preferred embodiment are not the same as general registers which are typically operated on by the CPU 102 in executing RISC instructions. The special registers stored in the CPU register file include a Java™ program count (jpc) register, a Java™ stack pointer (jsp) register, a local variable frame pointer (lvfp) register, a number of arguments and local variables (narg_nlocal) register, an upper limit of jsp (jspul) register, a lower limit of jsp (jspll), a thread counter (threadcnt) register, a virtual Java™ stack pointer (vjsp) register and a register indicating the number of stack registers used (used). Each of the general and special registers stored in the CPU register file are updated after each bytecode is translated by the hardware Java™ bytecode unit 100. The jpc (or program counter) register keeps track of where in memory the Java™ Virtual Machine should be executing instructions. The other registers will be described in detail below.

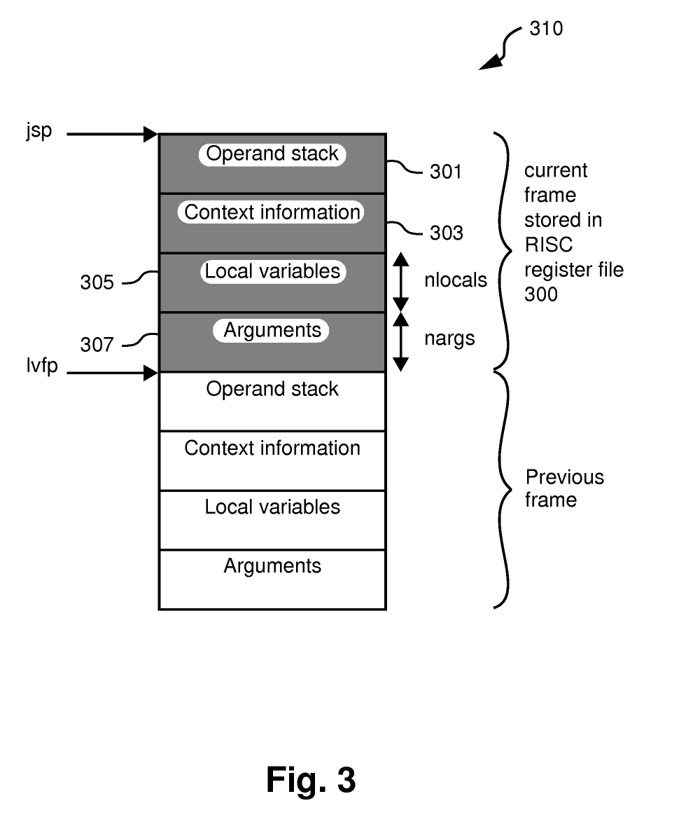

The CPU register file also stores the Java™ stack. As described above, the Java™ stack is used to keep track of the state of each method invocation, where the state of a method invocation is represented by a Java™ stack frame. The jsp and lvfp registers point to different parts of a current Java™ stack frame. As seen in FIG. 3, there are four sections in a Java™ stack frame 300 of the Java™ virtual machine being executed by the CPU 102, according to the preferred embodiment. The four sections include the operand stack (OS) 301, a context information (CI) section 303, a local variables (LV) section 305 and an arguments (ARG) section 307.

The local variables (LV) section 305 contains all the local variables (i.e., up to a number of local variables, nlocals) being used by the current method invocation. These variables are allocated upon the current method being invoked.

The execution of bytecodes may cause pushing of elements, or popping of elements to/from the operand stack (OS) 301. The operand stack (OS) 301 is used as a work space by bytecodes. The parameters for bytecodes being executed are placed in the operand stack 301, and results of bytecode instructions are found in the operand stack 301. The top of the operand stack 301 is pointed to by the jsp register. The operand stack (OS) 301 of the currently executing method is always the topmost stack section, and the jsp register therefore always points to the top of the entire Java™ stack. The lvfp register points to the beginning of the current Java™ stack frame.

The arguments section (ARG) 307 is used for parameter parsing from an invoker method (i.e., up to a number of arguments, nargs) to the invoked method (i.e., the method being invoked by the invoker method). Once the invocation of a method is completed, the arguments are treated as local variables inside the invoked method.

The context information (CI) section 303 is used to store all of the information required to return to the previous method.

The CPU register file is also used to store a portion of the general purpose registers for use as a buffer for the current stack frame of the Java™ stack. This buffer is referred to as the Java™ register stack. The Java™ register stack only keeps the registers in the stack frame associated with the currently executing method. Upon invocation of the method and subsequent return of the method, spill and fill, as will be described in detail below, will be performed to ensure that the Java™ register stack only contains the current stack frame.

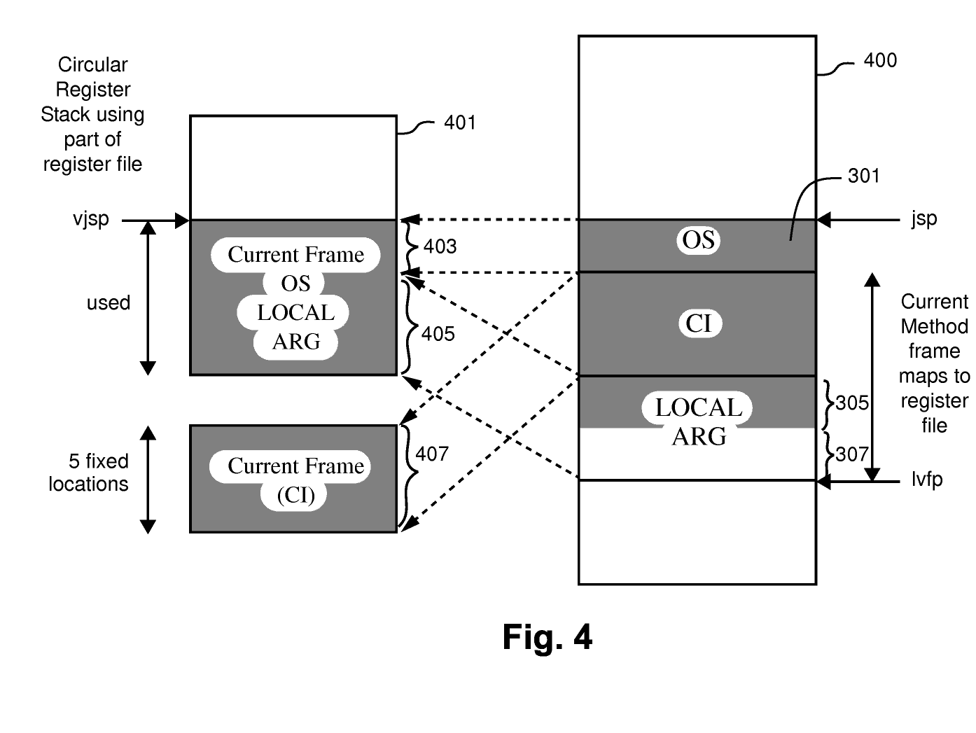

FIG. 4 shows the mapping of the Java™ stack 400 and the Java™ register stack 401. A portion (e.g., 403) of the Java™ register stack is reserved for the buffering of the operand stack (OS) 301. A further portion (e.g., 405) of the Java™ register stack is reserved for the local variables (LV) section 305 and the arguments section (ARG) 307 of the current stack frame. A still further portion (e.g., 407) of the Java™ register stack is reserved for the context information (CI) section 303 of the current stack frame 300. As seen in FIG. 4, the virtual Java™ stack pointer (vjsp) register points to the top of the Java™ register stack. Further, the used register indicates the number of registers used in buffering of the operand stack (OS) 301, the context information (CI) section 303 and the local variables (LV) section 305.

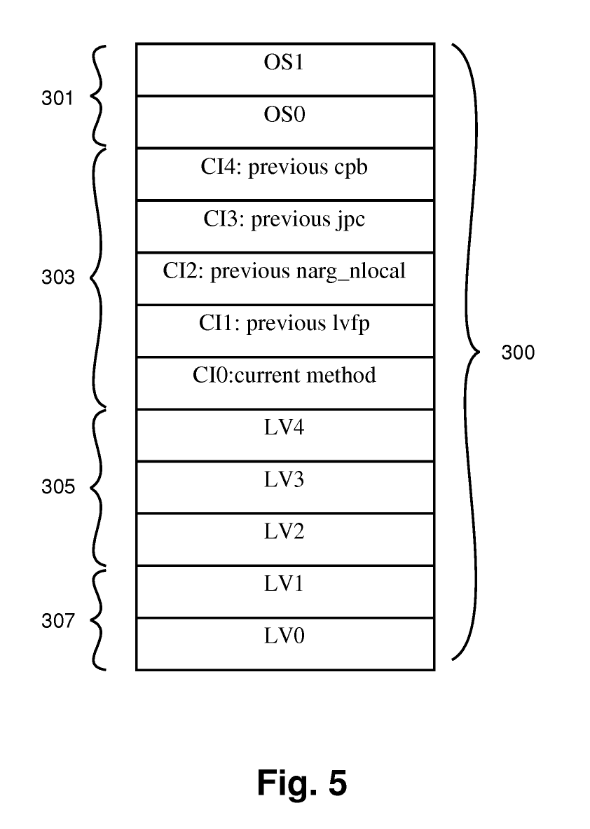

As seen in FIG. 5, there are five words, CI0, CI1, CI2, CI3 and CI4 stored in the context information (CI) section 303 of the current stack frame 300. Four of the words CI1, CI2, CI3 and CI4 are used to store the information in a context information (CI) section of a previous Java™ stack frame (e.g., stack frame 309 of FIG. 3). The word CI1 stores the value of the lvfp register of the previous Java™ stack frame. The word CI2 stores the number of arguments and local variables (narg_nlocal), of the previous Java™ stack frame. The word CI3 stores the jpc of the previous Java™ stack frame. The word CI4 stores the Java™ Constant Pool Base Pointer (CPB) of the previous Java™ stack frame. The remaining word, CI0, stores a reference to the current stack frame (i.e., stack frame 300) associated with the current method. The word CI0 is used for synchronisation checking and to keep track of the method running in each stack frame.

Table 1, below, shows the general register used when the CPU 102 is operating in Java™ mode (i.e., when the hardware Java™ bytecode unit 100 is translating stack-based Java™ bytecodes into register-based RISC instructions):

TABLE 1

| Register Number | Alias | Usage |
|---|---|---|
| $r0 | $0 | Ties to zero |
| $r1–$r22 | $vn | Buffer of elements (OS, LOCAL, ARG) in |
| | | current frame |
| $r23 | $ci0 | Context information - current method ptr |
| $r24 | $ci1 | Context information - previous lvfp |
| $r25 | $ci2 | Context information - previous narg_nlocal |
| $r26 | $ci3 | Context information - previous jpc |
| $r27 | $ci4 | Context information - previous cpb |
| $r28 | $jsp | Java Stack Pointer (in case of spilling and |
| | | filling) |
| $r29 | $nsp | Native Stack Pointer |
| $r30 | $cpb | Constant Pool Base Pointer |
| $r31 | | Stores the return address back to Native mode |

The bytecode unit 102 has eight special registers which are also stored in the CPU register file and are used for managing the Java™ stack stored in the CPU register file. The CPU 102 can access these eight special registers using load-store instructions. The eight special registers of the bytecode unit 102 are described in Table 2, below:

TABLE 2

| Index | Register | Description |
|---|---|---|
| 1 | $jpc | The Java PC |
| 2 | $jsp | The Java Stack Pointer |
| 3 | $lvfp | The Local Variable Frame Pointer |
| 4 | $narg_nlocal | The No. of args (31:16) and the No. of |
| | | local (15:0) |
| 5 | $jspul | The upper limit of jsp |
| 6 | $jspll | The lower limit of jsp |
| 7 | $threadcnt | The thread counter |
| 8 | $vjsp | The Virtual Java Stack Pointer |
| 9 | $used | The No. of stack registers used |

The hardware Java™ bytecode unit 100 uses a RISC instruction set look-up table for translating Java™ bytecodes into native instructions for execution by the CPU 102. The look-up table stores the RISC instruction set used by the CPU 102. To translate a particular Java™ bytecode into one or more RISC instructions, the hardware Java™ bytecode unit 100 uses the particular Java™ bytecode as an index into the look-up table. The Java™ bytecode unit 100 matches the particular Java™ bytecode to one or more RISC instructions stored in the look-up table. The matched RISC instructions may then be executed by the CPU 102. The instruction set look-up table is programmable and may be updated during runtime to improve performance and functionality of the hardware Java™ bytecode unit 100.

The CPU 102 is executing a typical RISC CPU pipeline. In accordance with such a RISC CPU pipeline, the CPU 102 comprises an instruction cache 102, a multiplexer 104, an instruction fetch unit 105, a multiplexer 106, an instruction dispatch unit 107, and an integer unit 108. When operating in native mode, the instruction fetch unit 105 of the CPU 102 fetches one or more native RISC instructions (per clock cycle) from the instruction cache 103, via an internal bus 109. The instruction fetch unit 105 accesses the instruction cache 103 by sending an instruction address to the instruction cache 102 via an internal bus 117 and the multiplexer 104. The RISC instructions are typically fetched into an instruction queue (not shown) incorporated within the instruction fetch unit 105. The instruction fetch unit 105 sends the RISC instructions to the instruction dispatch unit 107, via the multiplexer 106 and internal buses 110 and 111. The instruction dispatch unit 107 decodes the RISC instructions before dispatching the RISC instructions to the integer unit 108 via an internal bus 112.

The integer unit 108 may be a fixed-point arithmetic logic unit (ALU) that performs all integer maths including instruction address calculations and executes the RISC instruction. The integer unit 108 may perform integer and floating-point load-address calculations, integer and floating-point store-address calculations, integer and floating-point load-data operations and integer store-data operations in accordance with the RISC instruction received from the instruction dispatch unit 107. The integer unit 108 performs these calculations and operations using the operand stack (OS) 301 stored in the CPU register file. The integer unit 108 accesses the operand stack (OS) 301 stored in the CPU register file via the hardware bus 127 which is referred as a “Register Load/Store” bus, as seen in FIG. 1. For example, the integer unit 108 may use the bus 127 for programming the hardware Java™ bytecode unit 100 special registers (e.g., jpc) (as shown in Table 2) stored in CPU register file. Further, the integer unit 108 may use the bus 127 for accessing the Java™ stack 400 in order to determine the status of the hardware Java™ bytecode unit 100 during any bytecode translation or mode switching operation. The general registers (as shown in Table 1) stored in the CPU register file will also be updated based on the RISC instruction executed by the integer unit 108, via the bus 127.

As seen in FIG. 1, hardware bus 125 is referred to as a “Branch controls” bus. The hardware Java™ bytecode unit 100 is configured to perform branching and has branch capability. As such, the hardware Java™ bytecode unit 100 pre-translates speculative bytecode instructions before knowing branch results. The hardware Java™ bytecode unit 100 accesses branch results from the integer unit 108 for a particular branch and may use the branch results to correct a target address and invalidate instructions, if necessary.

The CPU 102 also executes the Java™ virtual machine which is responsible for interpreting any Java™ bytecodes fetched from the instruction cache 103. In accordance with the embodiment of FIG. 1, the hardware Java™ bytecode unit 100 implements at least part of the Java™ Virtual Machine in hardware. The hardware Java™ bytecode unit 100 increases the speed of processing of Java bytecodes. The hardware Java™ bytecode unit 100 at least partially performs the translation of the Java bytecodes into native RISC instructions for the CPU 102.

As seen in FIG. 1, the hardware Java™ bytecode unit 100 shares the instruction cache 103 with the instruction fetch unit 105 using the multiplexer 104. The hardware Java™ bytecode unit 100 also shares the instruction dispatch unit 107 with the instruction fetch unit 105 using the multiplexer 106. Instructions from the instruction cache 103 may be supplied to either the instruction fetch unit 105, as described above, or to the hardware Java™ bytecode unit 100, via the internal bus 109.

When the CPU 102 is initially “powered on”, the CPU 102 is in “native mode” and the multiplexers 104 and 106 are set to bypass the hardware Java™ bytecode unit 100. In the native mode, the CPU 102 executes native RISC instructions supplied to the instruction fetch unit 102 via the bus 109. The instruction fetch unit 102 accesses the instruction cache 103 by sending an instruction address referencing a RISC instruction to the instruction cache 103 via the internal buses 115, 117 and the multiplexer 104.

If the instruction cache 103 contains a Java™ bytecode, then the Java™ Virtual Machine being executed by the CPU 102 switches the CPU 102 to Java™ mode. In this instance, the Java™ Virtual Machine initialises the special and general registers stored in the CPU register file and sends a “load/store” to the hardware Java™ bytecode unit 100. The Java™ Virtual Machine also sends a “change mode” instruction down the RISC CPU pipeline of the CPU 102 upon switching the CPU 102 to Java™ mode. The change mode instruction results in a signal being sent to the multiplexer 104, via a bus 122. This signal switches the multiplexer 104 so that the hardware Java™ bytecode unit 100 may access the Java™ bytecode stored in the instruction cache 103. The change mode instruction also results in a signal being sent to the multiplexer 106, via a bus 123, which switches the multiplexer 106 so that RISC instructions output from the hardware Java™ bytecode unit 100 are supplied to the instruction dispatch unit 107, via the a bus 129. In order to access the Java™ bytecode in the instruction cache 102, the bytecode unit 100 sends an instruction address referencing the Java™ bytecode to the instruction cache 102 via a bus 113, the multiplexer 104 and an internal bus 115. The instruction cache 103 supplies the Java™ bytecode referenced by the instruction address to the bytecode unit 100 via the internal bus 109. The instruction fetch unit 105 is essentially disabled when the CPU is in a Java™ mode.

In this instance, the hardware Java™ bytecode unit 100 converts the Java™ bytecode into a RISC instruction by using the Java™ bytecode as an index into a programmable lookup table stored in the Java™ bytecode unit 100. As described above, the programmable lookup table stores the RISC instruction set used by the CPU 102. The RISC instruction is supplied to the instruction dispatch unit 107 by the hardware Java™ bytecode unit 100 via an internal bus 110 and the multiplexer 106. The instruction dispatch unit 107 decodes the RISC instruction and dispatches the decoded instruction to the integer unit 108. The integer unit 108 may perform integer and floating-point load-address calculations, integer and floating-point store-address calculations, integer and floating-point load-data operations and integer store-data operations in accordance with the RISC instruction received from the instruction dispatch unit 107. The integer unit 108 performs these calculations and operations using the operand stack (OS) 301 stored in the CPU register file. As described above, the integer unit 108 accesses the operand stack (OS) 301 stored in the CPU register file via the hardware bus 127. Further, the integer unit 108 may use the bus 127 for accessing the Java™ stack 400 in order to determine the status of the hardware Java™ bytecode unit 100 during any bytecode translation or mode switching operation. The general registers (as shown in Table 1) stored in the CPU register file will also be updated, via the bus 127, based on the RISC instruction received from the instruction dispatch unit 107.

The hardware Java™ bytecode unit 100 increases the processing speed of the Java™ Virtual Machine being executed by the CPU 102 allowing existing native language legacy applications and development tools to be used. Typically, a RISC CPU executing a Java™ Virtual Machine would not be able to access such legacy applications.

In another embodiment, the hardware Java™ bytecode unit 100 may be incorporated into a central processing unit such as the CPU 102. In such an embodiment, the translation of Java™ bytecodes into native RISC instructions for the CPU 102 may be performed by a hardware Java™ bytecode sub-unit of the CPU 102.

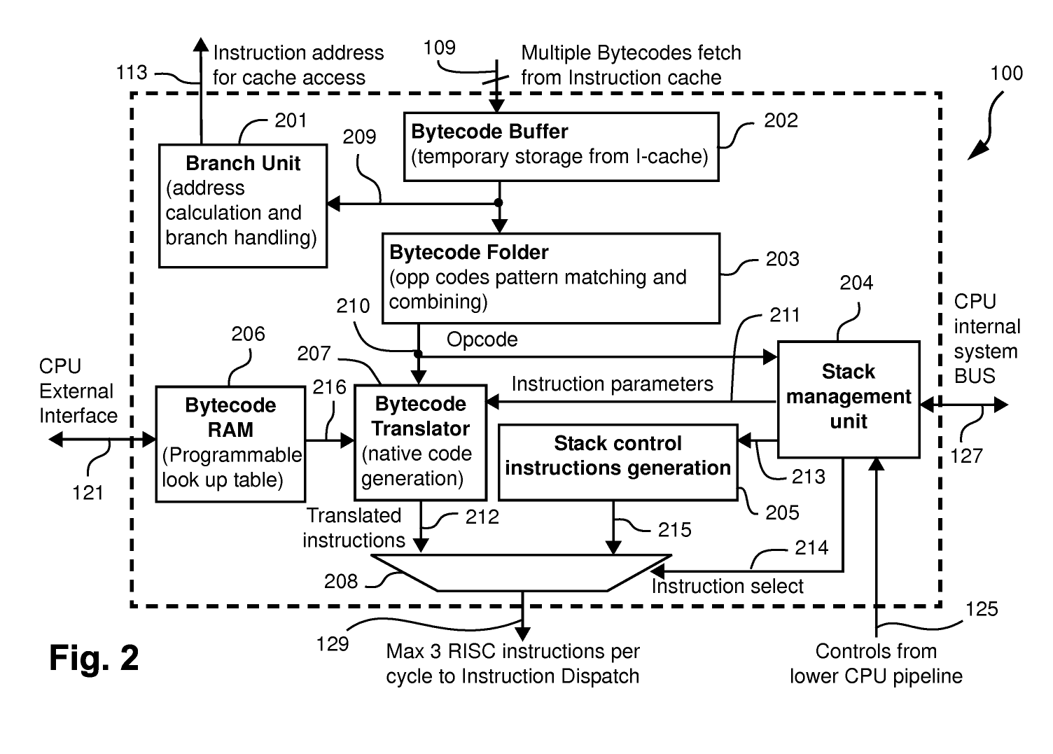

FIG. 2 shows details of one embodiment of the hardware Java™ bytecode unit 100. As seen in FIG. 2, the bytecode unit 100 comprises a branch unit 201, a bytecode buffer 202, a bytecode folder 203, a stack management unit 204, a stack control instructions generation unit 205, bytecode ram 206, a bytecode translator 207 and a multiplexer 208.

When the CPU 102 is in Java™ mode, the bytecode unit 201 fetches bytecodes from the instruction cache 102. In order to access the instruction cache 102, the branch unit 201 sends an instruction address to the instruction cache 102 via the hardware bus 113, the multiplexer 104 and the internal bus 115. The instruction cache 103 supplies a Java™ bytecode referenced by the instruction address to the bytecode buffer 202 via the bus 109. In the preferred embodiment, the bytecode buffer 202 may store up to sixteen Java™ bytecodes in an instruction queue.

A Java™ bytecode stored in the bytecode buffer 202 is sent to the bytecode folder 203, via an internal bus 209. The bytecode folder 203 matches the Java™ bytecode to an operation code (op-code) using op-code pattern matching and sends the op-code to the stack management unit 204 via an internal bus 210. The bytecode folder 203 may combine several of the Java™ bytecodes stored in the bytecode buffer 202 into a single RISC op-code.

The stack management unit 204 uses the op-code received from the bytecode folder 203 to generate RISC instruction parameters which are supplied to the bytecode translator 207 via an internal bus 211. The stack management unit 204 also provides update values for various stack pointers (i.e., the Java™ stack pointer (jsp) register and the virtual Java™ stack pointer (vjsp) register). These update values are sent to the stack control instruction generation unit 205 which generates stack control instructions for the operand stack (OS) 301 stored in the CPU register file.

The bytecode folder 209 also sends the op-code to the bytecode translator 207 via the internal bus 210. The bytecode translator 207 translates the op-code received from the bytecode folder 203 and the RISC instruction parameters received from the stack management unit 204 into a RISC instruction native to the CPU 102. The bytecode translator 207 uses a programmable instruction set lookup table stored in the bytecode RAM 206 to determine the RISC instruction. As described above, the look-up table stores the RISC instruction set used by the CPU 102. In translating the op-code, the bytecode translator 207 provides an address to the instruction set lookup table stored in the bytecode RAM 206 via an internal bus 216. This address indicates the location in the bytecode RAM 206 of the native RISC instruction for the CPU 102. Accordingly, the address provided by the bytecode translator 207 forms the index, as described above, into the look-up table.

The RISC instruction determined by the bytecode translator 207 is sent to the instruction dispatch unit 107 of the CPU 102, together with the stack control instructions generated by the stack control instruction generation unit 205, via the multiplexer 208, the multiplexer 106, and the buses 129 and 215. As described above, the instruction dispatch unit 107 decodes the RISC instruction before dispatching the RISC instruction to the integer unit 108 for execution, via the internal bus 111. The integer unit 108 may then perform integer and floating-point load-address calculations, integer and floating-point store-address calculations, integer and floating-point load-data operations and integer store-data operations in accordance with the RISC instruction received from the instruction dispatch unit 107. The integer unit 108 performs these calculations and operations using the operand stack (OS) 301 stored in the CPU register file according to the stack control instructions generated by the stack control generation unit 205. As described above, the integer unit 108 accesses the operand stack (OS) 301 stored in the CPU register file via the hardware bus 127. Further, the integer unit 108 may use the bus 127 for accessing the Java™ stack 400 in order to determine the status of the hardware Java™ bytecode unit 100 during any bytecode translation or mode switching operation. The general registers (as shown in Table 1) and also the special registers (as shown in Table 2) stored in the CPU register file will be updated based on the executed RISC instruction received from the instruction dispatch unit 107.

If the bytecode translator 207 receives a non-translatable bytecode from the bytecode folder 203, the bytecode translator 207 generates the change mode instruction, which is sent to the CPU 102. Upon receiving the change mode instruction, the multiplexers 104 and 106 of the CPU 102 are switched to native mode, via signals on the buses 122 and 123, allowing the instruction fetch unit 105 to access the instruction cache 103 in order to fetch the non-translatable bytecode from the instruction cache 103. This non-translatable bytecode may then be executed by the Java™ Virtual Machine being executed by the CPU 102.

As described above, the instruction set look-up table is programmable and may be updated during runtime to improve performance and functionality of the hardware Java™ bytecode unit 100. The look-up table may be programmed by a programmer, for example, using an external interface 119 as seen in FIG. 1. The external interface communicates with the hardware Java™ bytecode unit 100 via a bus 121. The look-up table may be updated at run-time for different application usage. For example, debug instructions may be inserted by the programmer using the external interface 119 in order to “code trace” as known to those skilled in the relevant art. As another example, certain bytecodes may be optimised for performance purposes if the CPU 102 predetermines that not all of the security features of the bytecodes are required to execute the bytecodes. Still further, the look-up table may be modified for different central processing units having different issue capability, for example, for central processing units configured to issue multiple instructions in a single cycle. The hardware Java™ bytecode unit 100 may be integrated with single or multi-issue central processing units with configurable numbers of instruction ports.

The stack control instructions for the Java™ stack generated by the stack control instruction generation unit 205 are sent to the CPU 102 via the multiplexer 208 and the multiplexer 106. The CPU register file register stack 401 and the Java™ stack 400 are updated based on the stack control instructions. In particular, the state of the Java™ virtual machine being executed by the CPU 102 and the pointer to the top of the operand stack (OS) 301 are updated based on the stack control instructions.

The register stack 401 stored in the CPU register file acts as a circular buffer for the Java™ stack 400. The Java™ stack 400 grows and shrinks during execution of the Java™ Virtual Machine as Java™ bytecodes are translated into register-based RISC instructions for the CPU 102. Due to the limited number of registers in the register stack 401, data needs to be moved out of the register stack 401 to the RAM 206 (i.e., the data is “spilled”) and access data from the RAM 206 (i.e., the register stack 401 is “filled”).

Under certain conditions, the stack management unit 204 interrupts normal bytecode translation and sends instructions for stack management to the bytecode translator 207. In particular, the hardware Java™ bytecode unit 100, performs automatic spilling and filling of the Java™ stack 400 to and from the bytecode RAM 206 using load and store instructions generated by the stack management unit 204 during the translation of Java™ bytecodes into register-based RISC instructions for the CPU 102. These load and store instructions are sent to the bytecode translator 207 via an internal bus 211.

Normal bytecode translation will be interrupted and spilling will occur under the following conditions:
(i) when the translation of a bytecode requires more free general or special registers;
(ii) upon the CPU 102 being switched from native mode to Java™ mode, where all used registers of the CPU register file including the context information (CI) are spilled;
(iii) before method invocation;
(iv) upon method invocation, the allocation of local variables requires more free registers; and
(v) after method invocation, the register stack spills data until only elements in the current stack frame are stored in the register stack.

Normal bytecode translation will be interrupted and filling will occur under the following conditions:
(i) a bytecode currently being translated requires access to operand stack elements which are not stored in the CPU register file;
(ii) upon the CPU 102 being switched from native mode to Java™ mode, the elements, including the context information, for a current stack frame are filled;
(iii) after method return, the elements, including context information, for a current stack frame are filled.

The translation of stack-based Java™ bytecodes into register-based RISC instructions using the hardware Java™ bytecode unit 100 will now be described with reference to an example Java™ bytecode, “iadd”. The op-code for iadd is 0x60. The bytecode iadd processes two integer operands at the top of the register stack (e.g., 401) stored in the CPU register file—other types of operands are illegal and would cause the bytecode translation to fail. Both operands are popped from the operand stack (OS) (e.g., 301) of the register stack stored in the CPU register file and the integer sum of both operands is pushed back on to the register stack. In order to translate the iadd bytecode into register-based RISC instructions, the CPU 102 switches the hardware Java™ bytecode unit 100 to Java™ mode. In Java™ mode, the bytecode unit 201 fetches the iadd bytecode from the instruction cache 102. In order to access the instruction cache 102, the branch unit 201 sends an instruction address for the iadd bytecode to the instruction cache 102 via the hardware bus 113, the multiplexer 104 and the internal bus 115. The instruction cache 103 supplies the iadd bytecode to the bytecode buffer 202 via the bus 109.

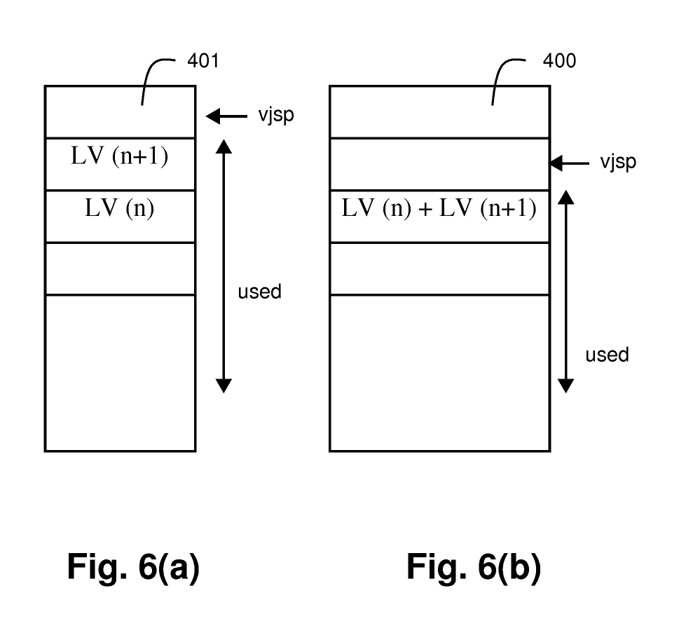

The iadd bytecode stored in the bytecode buffer 202 is sent to the bytecode folder 203, via an internal bus 209. The bytecode folder 203 matches the iadd bytecode to the op-code, 0x60, using op-code pattern matching and sends the op-code 0x60 to the stack management unit 204 via an internal bus 210. The stack management unit 204 uses the op-code 0x60 received from the bytecode folder 203 to generate RISC instruction parameters including the RISC opcode for “add”, and register indices for two source registers (e.g., register vjsp-1 and register vjsp-2, as seen in FIG. 6(a)) and one destination register (e.g., register vjsp-1, as seen in FIG. 6(b)). Other RISC instruction parameters may be generated by the stack management unit 204 for other bytecodes. The RISC instruction parameters generated by the stack management unit 204 are combined into a complete RISC instruction, which is supplied to the bytecode translator 207 via an internal bus 211.The stack management unit 204 also provides update values for various stack pointers including the virtual Java™ stack pointer (vjsp) and the Java™ stack pointer (jsp). These stack pointers are updated as follows:

vjsp=vjsp−1 (i)

jsp=jsp−1 (ii)

These update values are sent to the stack control instruction generation unit 205 which generates stack control instructions for the operand stack (OS) of the register stack stored in the CPU register file.

The bytecode folder 209 also sends the op-code 0x60 to the bytecode translator 207 via the internal bus 210. The bytecode translator 207 translates the op-code 0x60 received from the bytecode folder 203 and the RISC instruction parameters received from the stack management unit 204 into a RISC instruction native to the CPU 102. The bytecode translator 207 uses the programmable instruction set lookup table stored in the bytecode RAM 206 to determine the RISC instruction. As described above, the look-up table stores the RISC instruction set used by the CPU 102. The RISC instruction in the programmable instruction set lookup table corresponding to the op-code 0x60 is “add $(vjsp−2), $(vjsp−1), $(vjsp−2)”. In translating the op-code, the bytecode translator 207 provides an address to the instruction set lookup table stored in the bytecode RAM 206 via an internal bus 216. This address indicates the location in the bytecode RAM 206 of the native RISC instruction “add $(vjsp−2), $(vjsp−1), $(vjsp−2)”, for the CPU 102.

The RISC instruction “add S(vjsp−2), $(vjsp−1), $(vjsp−2)” determined by the bytecode translator 207 is sent to the instruction dispatch unit 107 of the CPU 102, together with the stack control instructions (i.e., vjsp=vjsp−1 and jsp=jsp−1) generated by the stack control instruction generation unit 205, via the multiplexer 208, the multiplexer 106, and the buses 129 and 215. The instruction dispatch unit 107 decodes the RISC instruction “add $(vjsp−2), $(vjsp−1), $(vjsp−2)” before dispatching the RISC instruction to the integer unit 108 for execution, via the internal bus 111. The integer unit 108 may then perform integer and floating-point load-address calculations, integer and floating-point store-address calculations, integer and floating-point load-data operations and integer store-data operations in accordance with the RISC instruction “add $(vjsp−2), $(vjsp−1), S(vjsp−2)”. The integer unit 108 performs these calculations and operations using the operand stack (OS) stored in the CPU register file according to the stack control instructions generated by the stack control generation unit 205. The general registers and also the special registers, as described above, stored in the CPU register file will be updated based on the executed RISC instruction. In particular, the register representing the number of stack registers used (i.e., $used) and the Java™ program counter (jpc) are updated as follows:

used=used−1 (i)

jpc=jpc−1 (ii)

FIG. 6(a) shows the register stack 401 (stored in the CPU register file) prior to the translation of the iadd bytecode in accordance with the above example. As seen in FIG. 6(a), register vjsp-1 is one of the source registers and has a local variable LV(n+1) stored in the register. Further, the register vjsp-2 is the other one of the source registers and has a local variable LV(n) stored in the register. The number of registers used (i.e., $used) is equal to four (4). FIG. 6(b) shows the register stack 400 (stored in the CPU register file) after the translation of the iadd bytecode in accordance with the above example. As seen in FIG. 6(b), register vjsp-1 is the destination register and has a local variable (LV(n+1)+LV(n)) stored in the register. Further, the number of registers used (i.e., $used) is equal to three (3).

### INDUSTRIAL APPLICABILITY

It is apparent from the above that the arrangements described are applicable to the computer and data processing industries.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A system comprising:
a central processing unit for use in executing RISC instructions; and
a hardware unit associated with the central processing unit, the hardware unit being configured for translating stack-based instructions into RISC instructions for execution by said central processing unit, wherein the translation is performed using a programmable lookup table.

2. The system according to claim 1, wherein the hardware unit uses a stack-based instruction as an index into the programmable lookup table to translate said stack-based instruction into a RISC instruction.

3. The system according to claim 1, wherein said central processing unit comprises a CPU register file.

4. The system according to claim 3, wherein the hardware unit uses an operand stack configured within the CPU register file for performing the stack operations necessary in performing said translations.

5. The system according to claim 4, wherein the operand stack is used for performing all of the stack operations necessary for said translations.

6. The system according to claim 4, wherein the CPU register file comprises the entire operand stack.

7. The system according to claim 1, wherein the hardware unit is separate from the CPU.

8. The system according to claim 1, wherein the hardware unit is a subunit of the CPU.

9. The system according to claim 1, wherein the stack-based instructions are Java™ bytecodes.

10. The system according to claim 1, wherein the stack-based instructions are used by a virtual machine being executed by said CPU.

11. The system according to claim 4, wherein the RISC instructions generated by the hardware unit access the operand stack in the register file.

12. A system comprising:
a central processing unit for use in executing RISC instructions, said central processing unit comprising a CPU register file; and
a hardware unit associated with the central processing unit, the hardware unit being configured for translating stack-based instructions into RISC instructions using an operand stack configured within the CPU register file, wherein the operand stack is managed by the hardware unit and is used for performing the stack operations necessary in performing said translations.

13. The system according to claim 12, wherein the translation is performed using a programmable lookup table.

14. The system according to claim 13, wherein the hardware unit uses a stack-based instruction as an index into the programmable lookup table to translate said stack-based instruction into a RISC instruction.

15. The system according to claim 12, wherein the operand stack is used for performing all of the stack operations necessary for said translations.

16. The system according to claim 12, wherein the CPU register file comprises the entire operand stack.

17. The system according to claim 12, wherein the hardware unit is separate from the CPU.

18. The system according to claim 12, wherein the hardware unit is a subunit of the CPU.

19. The system according to claim 1, wherein the stack-based instructions are Java™ bytecodes.

20. The system according to claim 12, wherein the stack-based instructions are used by a virtual machine being executed by said CPU.

21. The system according to claim 1, wherein the RISC instructions generated by the hardware unit access the operand stack in the register file.

22. A method of translating a stack-based instruction into RISC instructions for execution by a central processing unit, said method comprising the steps of:
downloading the stack-based instruction to a hardware unit associated with the central processing unit;
matching the stack-based instruction to one or more RISC instructions stored in a programmable lookup table, using the hardware unit; and
executing the one or more RISC instructions using the central processing unit.

23. The method according to claim 22, wherein the central processing unit comprises a CPU register file.

24. The method according to claim 23, further comprising the step of accessing an operand stack configured within the CPU register file, using the hardware unit, to perform the stack operations necessary in performing the translations.

25. The method according to claim 24, wherein the operand stack is used for performing all of the stack operations necessary for said translations.

26. The method according to claim 24, wherein the CPU register file comprises the entire operand stack.

27. The method according to claim 22, wherein the hardware unit is separate from the CPU.

28. An apparatus comprising:
a central processing unit for use in executing RISC instructions; and
a hardware unit associated with the central processing unit, the hardware unit being configured for translating stack-based instructions into RISC instructions for execution by said central processing unit, wherein the translation is performed using a programmable lookup table to match stack-based instructions to one or more RISC instructions stored in the programmable lookup table.
